(19) United States
(12) Patent Application Publication
(10) Pub. No.: US 2013/0209343 A1
(43) Pub. Date: Aug. 15, 2013

(54) LIQUID PHASE SYNTHESIS OF TRISILYLAMINE

(71) Applicant: Andrey V. KOROLEV, Newark, DE (US)

(72) Inventor: Andrey V. KOROLEV, Newark, DE (US)

(73) Assignee: American Air Liquide, Inc., Fremont, CA (US)

(21) Appl. No.: 13/371,010

(22) Filed: Feb. 10, 2012

(51) Int. Cl. C01B 21/087

(52) U.S. Cl. 423/324

(57) ABSTRACT

Disclosed are liquid phase synthesis methods to produce trisilylamine.

### TECHNICAL FIELD

Disclosed are liquid phase synthesis methods to produce trisilylamine suitable for use in semiconductor processing.

### BACKGROUND

Trisilylamine (TSA) is a precursor used in semiconductor processing for deposition of silicon nitride, silicon oxynitride and silicon oxide films. See, e.g., U.S. Pat. No. 7,192,626 to Dussarrat et al. Its low boiling point (b.p. 52° C.) and lack of carbon atoms in the structure make it particularly attractive for use in deposition of high purity SiN and SiO films by CVD or ALD methods. The electronics industry recognizes the advantages of TSA, and demand for this material is growing. This dictates the necessity for development of a robust large-scale industrial process for TSA production.

A gas phase reaction between monohalosilane and ammonia has been used to produce TSA for almost a century. See, e.g., Stock et al., Ber. 1921, 54, 740; Burg et al., J. Am. Chem. Soc., 1950, 72, 3103; Wells et al., J. Am. Chem. Soc., 1966, 88, 37; Ward et al., Inorg. Synth., 1968, 11, 168; and US 2010/0310443 to Miller. The gas phase reaction proceeds according to the following equation:

3 SiH₃X (g)+4 NH₃ (g)→N(SiH₃)₃ (I)+3 NH₄X (s) (X=Cl, Br)

The gas phase reaction generally produces TSA in moderate to high yield and purity. The big disadvantage of this process, when done on an industrial scale, is the formation of large quantities of solid by-products, particularly NH₄Cl. Removing these by-products from the reactor is a very time consuming step that negatively affects production cost of TSA due at least partially to the resulting reactor downtime. Another method of producing TSA consists of pyrolysis of perhydropolysilazanes. See, e.g., US2011/0178322. Applicant does not believe that this method will be suitable for large-scale industrial processes.

A need remains for a commercially viable TSA production method.

### SUMMARY

Disclosed are methods of producing trisilylamine (TSA). A monohalosilane is added to a reactor containing an anhydrous solvent to form a solution at a temperature ranging from approximately −100° C. to approximately 0° C. Anhydrous ammonia gas is added to the solution to produce a mixture. The mixture is stirred to form a stirred mixture. TSA is isolated from the stirred mixture by distillation. The disclosed processes may further include one or more of the following aspects:
removing solid by-products from the stirred mixture by filtration prior to isolating TSA so that TSA is isolated from the filtered stirred mixture;
adding approximately 3 mL to approximately 20 mL of anhydrous solvent per approximately 1 g of monohalosilane;
adding approximately 6 mL to approximately 8 mL of anhydrous solvent per approximately 1 g of monohalosilane;
a molar ratio of the monohalosilane to the anhydrous ammonia gas being between 0.75:1 and 1.5:1;
a molar ratio of the monohalosilane to the anhydrous ammonia gas being between 1:1 to 1.5:1;
a molar ratio of the monohalosilane to the anhydrous ammonia gas being between 1.1:1 to 1.5:1;
the monohalosilane reactant having a purity ranging from approximately 90% mol/mol to approximately 100% mol/mol;
the monohalosilane reactant having a purity ranging from approximately 95% mol/mol to approximately 100% mol/mol;
the monohalosilane reactant having a purity ranging from approximately 98% mol/mol to approximately 100% mol/mol;
the monohalosilane reactant having a concentration of dihalosilane ranging from approximately 0% mol/mol to approximately 10% mol/mol;
the monohalosilane reactant having a concentration of dihalosilane ranging from approximately 0% mol/mol to approximately 5% mol/mol;
the monohalosilane reactant having a concentration of dihalosilane ranging from approximately 0% mol/mol to approximately 1% mol/mol;
the monohalosilane being monochlorosilane;
the anhydrous solvent being selected from the group consisting of hydrocarbons, halo-hydrocarbons, halocarbons, ethers, polyethers, and tertiary amines;
the anhydrous solvent being selected from the group consisting of toluene, heptane, ethylbenzene, and xylenes;
the anhydrous solvent being toluene;
the temperature of both addition steps ranging from approximately −90° C. to approximately −40° C.;
the temperature of both addition steps ranging from approximately -78° C. to approximately −60° C.;
the pressure of both addition steps being approximately 91 kPa to approximately 112 kPa;
stirring the mixture for approximately 1 hour to approximately 48 hours;
the distillation being atmospheric fractional distillation or vacuum fractional distillation;
the distillation being atmospheric fractional distillation;
the isolated TSA having a purity ranging from approximately 50% mol/mol to approximately 90% mol/mol;
purifying the isolated TSA by fractional distillation; and
the purified TSA having a purity ranging from approximately 97% mol/mol to approximately 100% mol/mol.

### Notation and Nomenclature

Certain abbreviations, symbols, and terms are used throughout the following description and claims, and include:

As used herein, the abbreviation “TSA” refers to trisilylamine, the abbreviation “CVD” refers to chemical vapor deposition, the abbreviation “ALD” refers to atomic layer deposition, the abbreviation “g” refers to gas, the abbreviation “I” refers to liquid, and the abbreviation “s” refers to solid.

The standard abbreviations of the elements from the periodic table of elements are used herein. It should be understood that elements may be referred to by these abbreviations (e.g., Al refers to aluminum, Ca refers to calcium, Cr refers to chromium, etc.).

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is an exemplary system suitable to perform the disclosed methods;

FIG. 2 is an alternate exemplary system suitable to perform the disclosed methods; and

FIG. 3 is another alternate exemplary system suitable to perform the disclosed methods.

### DESCRIPTION OF PREFERRED EMBODIMENTS

Disclosed are methods of producing trisilylamine (TSA). The disclosed method utilizes a reaction of liquid monohalosilane with anhydrous ammonia as described in the following equation:

3 SiH₃X (I)+4 NH₃ (g or I)→N(SiH₃)₃ (I)+3 NH₄X (s suspended in solvent) (X=F, Cl, Br, I)

The monohalosilane is added to a reactor containing an anhydrous solvent to form a solution at a temperature ranging from approximately −100° C. to approximately 0° C., preferably ranging from approximately −90° C. to approximately −40° C., and more preferably from approximately −78° C. to approximately −60° C. Although the reactants and TSA will remain liquids at higher pressures, the pressure in the reactor is preferably around atmospheric pressure (approximately 91 kPa to approximately 112 kPa). The ratio of anhydrous solvent to monohalosilane is chosen from the range of approximately 3 mL to approximately 20 mL of anhydrous solvent per approximately 1 g of monohalosilane, preferably approximately 6 mL to approximately 8 mL of anhydrous solvent per approximately 1 g of monohalosilane.

The monohalosilane may be monofluorosilane, monochlorosilane, monobromosilane, or monoiodosilane. Preferably, the monohalosilane is monochlorosilane. As monohalosilanes may degrade with time to dihalosilanes and trihalosilanes, care should be taken to ensure that the monohalosilane reactant has a purity ranging from approximately 90% mol/mol to approximately 100% mol/mol. Preferably, the monohalosilane has a purity ranging from approximately 95% mol/mol to approximately 100% mol/mol, and more preferably from approximately 98% mol/mol to approximately 100% mol/mol. Monohalosilane reactants having a dihalosilane content of approximately 10% mol/mol to approximately 90% mol/mol lead to low yields of TSA due to formation of monohalosilyl disilylamine and polysilazanes. Therefore, the dihalosilane content in the monohalosilane reactant may range from approximately 0% mol/mol to approximately 10% mol/mol, preferably from approximately 0% mol/mol to approximately 5% mol/mol, and more preferably from approximately 0% mol/mol to approximately 1% mol/mol.

The anhydrous solvent may be a hydrocarbon, halo-hydrocarbon, halocarbon, ether, polyether (acyclic or cyclic), or tertiary amine (aliphatic or aromatic). The selected anhydrous solvent is not reactive with any of the reactants or products, including the monohalosilane, ammonia, and TSA. Furthermore, the anhydrous solvent must be a liquid at the reaction temperature. Therefore, the selected anhydrous solvent remains a liquid at temperatures ranging between −100 ° C. and the boiling point of the anhydrous solvent. Finally, the anhydrous solvent must be dry (anhyrdrous) in order to prevent the formation of oxygenated species, such as disiloxanes. The anhydrous solvent may contain between approximately 0 ppm and approximately 100 ppm moisture. Preferably, the anhydrous solvent contains between approximately 0 ppm and approximately 10 ppm moisture.

Exemplary anhydrous solvents include toluene, heptane, ethylbenzene, or one or more of the xylenes. The xylenes are 1,2-dimethylbenzene, 1,3-dimethylbenzene, and 1-4-dimethylbenzene. Preferably, the anhydrous solvent is toluene because (1) it does not freeze at −78° C. and (2) the large difference in its boiling point (111° C.) from that of TSA (52° C.) results in easier separation by distillation. Other anhydrous solvents having properties similar to toluene are also preferable in the disclosed methods.

Anhydrous ammonia is added to the solution formed to produce a mixture at a temperature ranging from approximately −100° C. to approximately 0° C., preferably ranging from approximately −90° C. to approximately −40° C., and more preferably at approximately −78° C. The anhydrous ammonia may be added as a liquid or a gas. However, at atmospheric pressure and temperatures below −33.35° C., gaseous ammonia will condense to liquid ammonia. Once again, the pressure in the reactor preferably remains around atmospheric pressure. Once again, the anhydrous ammonia may contain between approximately 0 ppm and approximately 100 ppm moisture. Preferably, the anhydrous ammonia contains between approximately 0 ppm and approximately 10 ppm moisture. A mass flow controller may be used to optimize the addition of the anhydrous ammonia. A person skilled in the art will recognize other methods that may be used to add the anhydrous ammonia (e.g., regulating valves, weight change cylinders, monitoring weight change in the reactor, etc.).

The molar ratio of the monohalosilane to the anhydrous ammonia gas is between 0.75:1 and 1.5:1 and preferably between 0.9:1 and 1.5:1. However, as demonstrated in the following examples, excess ammonia leads to low TSA yields and formation of unwanted by-products. Therefore, the molar ratio of monohalosilane to anhydrous ammonia gas is preferably 1:1 to 1.5:1. As further demonstrated in the following examples, excess monohalosilane produces good yields and purity of TSA. Therefore, the molar ratio of monohalosilane to anhydrous ammonia gas is more preferably 1.1:1 to 1.5:1.

The mixture may be stirred for approximately 1 hour to approximately 48 hours at the addition temperature range of approximately −100° C. to approximately 0° C., preferably from approximately −90° C. to approximately −40° C., and more preferably at approximately −78° C. The mixture produced comprises TSA, unreacted monohalosilane, the solvent in liquid form, NH₄X (X=F, Cl, Br, I) suspended in the mixture, and possible impurities.

In one embodiment, the stirred mixture may be filtered through a filter to remove the NH₄X (X=F, Cl, Br, I) solid by-products. Typical filters include glass or polymer frit filters. The filtrate (also known as the filtered stirred mixture) may then be warmed to room temperature. Unreacted monohalosilane may be vented through a distillation column. One of ordinary skill in the art may recover the vented excess monohalosilane by condensing and/or compressing it into a suitable container. TSA may then be isolated from the filtrate through a distillation column or by heating the filtrate to approximately the boiling point of the TSA. One of ordinary skill in the art will recognize that the TSA/solvent mixture may boil at any temperatures between the boiling point of TSA and the boiling point of the solvent depending upon the quantities of each present. Furthermore, as TSA is isolated from the warmed stirred mixture, the boiling point of the warmed stirred mixture will change.

In another embodiment, the stirred mixture may be warmed to room temperature (approximately 15° C. to approximately 30° C.). Unreacted monohalosilane may be vented through a distillation column. One of ordinary skill in the art may recover the vented excess monohalosilane by condensing and/or compressing it into a suitable container. The TSA may then be isolated from the warmed stirred mixture through a distillation column or by heating the reactor to approximately the boiling point of the TSA. Once again, one of ordinary skill in the art will recognize that quantities of TSA and solvent will determine the boiling point of the filtrate. Once again, as TSA is isolated from the filtrate, the boiling point of the warmed stirred mixture will change.

When the molar ratio of monohalosilane to anhydrous ammonia gas is approximately 0.9:1 to 1.1:1, the disclosed methods convert approximately 80% mol/mol to approximately 90% mol/mol of monohalosilane to TSA. The isolated TSA has a purity ranging from approximately 50% mol/mol to approximately 90% mol/mol.

The isolated TSA may be further purified by distillation. The purified TSA has a purity ranging from approximately 97% mol/mol to approximately 100% mol/mol, preferably from approximately 99% mol/mol to approximately 100% mol/mol. The purified TSA preferably has between the detection limit and 100 ppb of each potential metal contaminant (e.g., at least Al, Ca, Cr, Cu, Fe, Mg, Ni, K, Na, Ti, Zn, etc.). Suitable distillation methods include batch fractional distillation. The batch fractional distillation may be performed at low temperature and pressure, but is preferably performed at atmospheric pressure. Alternatively, the isolated TSA may be purified by continuous distillation over two distillation columns to separate TSA from high boiling impurities and low boiling impurities in sequential steps.

Unlike some monochlorosilanes, purified TSA exhibits good shelf-life stability. One sample, which was produced by a method different than disclosed herein, was tested by Nuclear Magnetic Resonance (NMR) and Gas Chromatography-Mass Spectrometry (GC-MS) after 2.5 years at room temperature and remained quite pure having approximately 97% mol/mol purity.

One of ordinary skill in the art will recognize the sources for the components of the systems used to practice the disclosed methods. Some level of customization of the components may be required based upon the desired temperature range, pressure range, local regulations, etc. Exemplary suppliers include Büchi Glas Uster AG, Shandong ChemSta Machinery Manufacturing Co. Ltd., Jiangsu Shajabang Chemical Equipment Co. Ltd, etc. Preferably the components are made of corrosion resistant materials, such as stainless steel, glass lined steel, steel with corrosion resistant liners, etc.

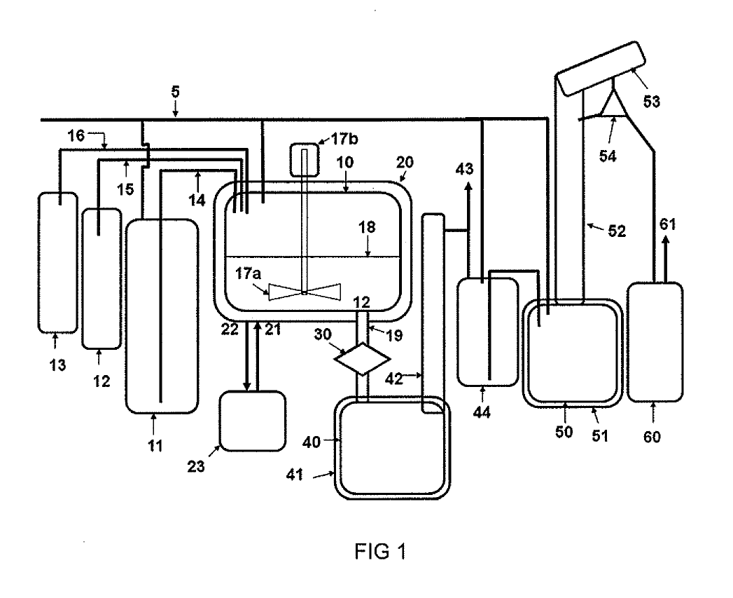

FIG. 1 is an exemplary system suitable to perform the disclosed methods. Air may be removed from various parts of the system (e.g., reactor 10, vessel 44, boiler 50) by an inert gas 5, such as nitrogen, argon, etc. The inert gas 5 may also serve to pressurize the solvent 11 to permit its delivery to reactor 10. Nitrogen, refrigerated ethanol, an acetone/dry ice mixture, or heat transfer agents such as monoethylene glycol (MEG) may be used to cool various parts of the system (e.g., reactor 10, distillation column 42, condenser 53).

The reactor 10 is maintained at the desired temperature by jacket 20. The jacket 20 has an inlet 21 and an outlet 22. Inlet 21 and outlet 22 may be connected to a heat exchanger/chiller 23 and/or pump (not shown) to provide recirculation of the cooling fluid. Alternatively, if the batch size is small enough and the mixing time short enough, jacket 20 may not require inlet 21 and outlet 22 because the thermal fluid may be sufficiently cold for the duration of the reaction.

The reactants (solvent stored in vessel 11, monohalosilane stored in vessel 12, and anhydrous ammonia gas stored in vessel 13) are added to reactor 10 via lines 14, 15, and 16, respectively. The reactants may be mixed in the reactor by an impeller 17a turned by motor 17b to form mixture 18. Preferably, the mixing is performed under an inert atmosphere at approximately atmospheric pressure. After suitable mixing, the mixture 18 may be removed from reactor 10 via drain 19 through filter 30 to container 40. In this embodiment, reactor 10 will most likely be located above filter 30 to best use the benefits of gravity. As the NH₄X (X=F, Cl, Br, I) (not shown) is suspended in the mixture 18, clogging of the reactor 10 is not a problem.

The filtered stirred mixture (filtrate) (not shown) may be collected in containers (not shown) and transported to a new location prior to performance of the next process steps. Alternatively, the filtrate may immediately be directed to a still pot 40 to isolate TSA from the filtrate using heater 41. The filtrate is warmed by heater 41. The heat forces excess monohalosilane through distillation column 42 and vent 43. Subsequently, TSA is separated from the higher boiling point solvent and collected in vessel 44.

Once again, vessel 44 may be transported to a new location prior to performance of the next process steps. The TSA may be transferred from vessel 44 to boiler 50 for further purification. Boiler 50 is heated by heater 51. TSA is purified by fractional distillation using distillation tower 52, condenser 53, and reflux divider 54. The purified TSA is collected in collection tank 60. Collection tank 60 includes vent 61.

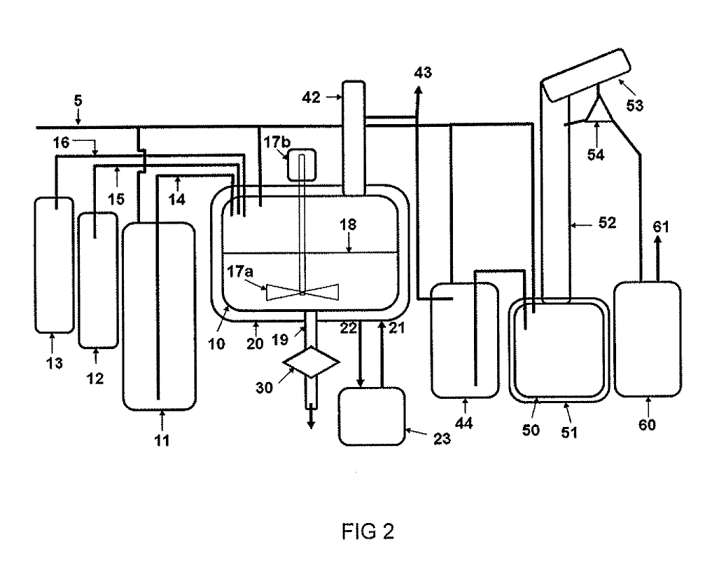

FIG. 2 is an alternate exemplary system suitable to perform the disclosed methods. In this alternative, reactor 10 also serves as the still pot 40 of FIG. 1. This embodiment may be useful for synthesis of large batches of TSA. After sufficient mixing, the cooling medium (not shown) in jacket 11 is replaced by a heating medium (not shown). One of ordinary skill in the art will recognize that “replacement” of the cooling medium will not be necessary if the cooling medium is also capable of acting as a heating medium (e.g., MEG). Instead, the temperature of the medium may be changed via, for example, heat exchanger.

Excess monohalosilane may be separated from the mixture 18 through distillation column 42 and vent 43. Subsequently, TSA is separated from the higher boiling point solvent and collected in vessel 44. The remaining solvent/salt mixture may be removed from reactor 10 via drain 19 with the salt collected on filter 30. Once again, vessel 44 may be transported to a new location prior to performance of the next process steps. The TSA may be transferred from vessel 44 to boiler 50 for further purification. Boiler 50 is heated by heater 51. TSA is purified by fractional distillation using distillation tower 52, condenser 53, and reflux divider 54. The purified TSA is collected in collection tank 60. Collection tank 60 includes vent 61.

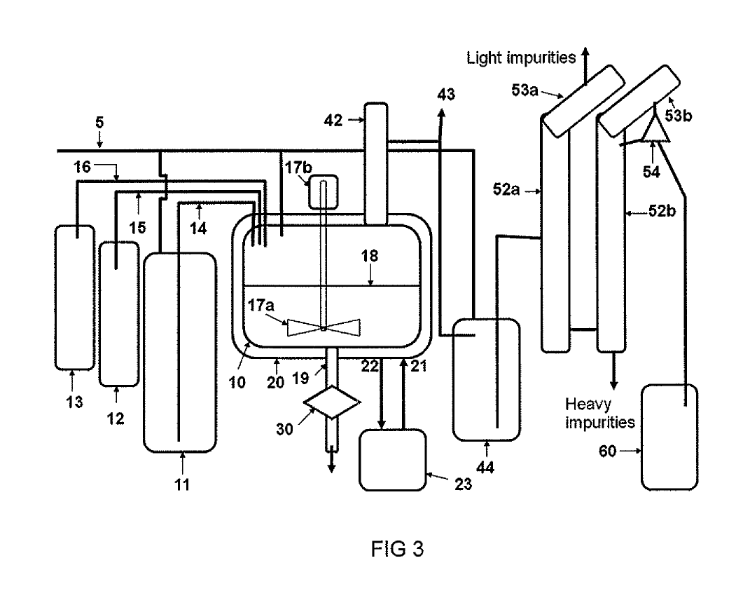

FIG. 3 is another alternate exemplary system suitable to perform the disclosed methods. In this alternative, the crude TSA in vessel 44 is purified by semi-continuous distillation over two distillation columns, 52a and 52b, in which the first column 52a removes the light impurities and the second column 52b removes the heavy impurities. Each distillation column has the associated condenser 53a and 53b, respectively.

One of ordinary skill in the art will recognize that many elements are not shown in the figures in order to provide a simplified view of the system. For example, one of ordinary skill in the art will recognize that the monohalosilane and/or the anhydrous ammonia gas may be introduced into the reactor through a pressure valve and mass flow controller. Additionally, one of ordinary skill in the art will recognize that additional valves, pumps, and flow controllers may be located at various other locations.

### EXAMPLES

The following non-limiting examples are provided to further illustrate embodiments of the invention. However, the examples are not intended to be all inclusive and are not intended to limit the scope of the inventions described herein.

### Example 1

### Synthesis of Trisilylamine in Toluene with Excess of MCS

Toluene (800 mL) was charged and cooled to −78° C. in a 2 L reaction flask equipped with magnetic stir bar, gas addition line and dry ice condenser. Monochlorosilane (130 g, 1.95 mol, 19.3% mol/mol excess vs. ammonia) was condensed to the reaction flask at −78° C. via gas addition line. Anhydrous ammonia gas (37.2 g, 2.18 mol) was slowly (in 1.5 h) added to the reactor at −78° C. via gas addition line. A white precipitate formed, and the mixture was warmed up and stirred at room temperature for 24 h and filtered through a pad of Celite brand diatomaceous earth. The solids on the filter were washed with 3×50 mL of toluene. TSA was isolated from the clear colorless filtrate by atmospheric pressure fractional distillation as a fraction boiling between 30 and 110° C. 40 g (68% mol/mol yield) of 91% mol/mol pure TSA was obtained, as determined by ¹H NMR.

### Example 2

### Synthesis of Trisilylamine in Toluene with Stoichiometric Amounts of MCS and NH₃

Toluene (900 mL) was charged and cooled to −78° C. in a 2 L reaction flask equipped with magnetic stir bar, gas addition line and dry ice condenser. Monochlorosilane (144 g, 2.16 mol, 0% mol/mol) excess vs. ammonia) was condensed to the reaction flask at −78° C. via gas addition line. Anhydrous ammonia gas (49.1 g, 2.88 mol) was slowly (in 2 h) added to the reactor at −78° C. via gas addition line. A white precipitate formed, and the mixture was warmed up and stirred at room temperature for 24 h and filtered through a pad of Celite brand diatomaceous earth. The solids on the filter were washed with 3×50 mL of toluene. TSA was isolated from the clear colorless filtrate by atmospheric pressure fractional distillation as a fraction boiling between 30 and 108° C. 49 g (64% mol/mol yield) of 92% mol/mol pure TSA was obtained, as determined by ¹H NMR.

### Example 3

### Synthesis of Trisilylamine in Toluene with Excess of Ammonia

Toluene (1000 mL) was charged and cooled to −78° C. in the 2 L reaction flask equipped with magnetic stir bar, gas addition line and dry ice condenser. Monochlorosilane (132 g, 1.98 mol) was condensed to the reaction flask at −78° C. via gas addition line. Anhydrous ammonia gas (50 g, 2.94 mol, 11% mol/mol excess vs. MCS) was slowly (in 2.5 h) added to the reactor at −78° C. via gas addition line. A white precipitate formed, and the mixture was warmed up and stirred at room temperature for 24 h and filtered through a pad of Celite brand diatomaceous earth. The solids on the filter were washed with 3×50 mL of toluene. TSA was isolated from the clear colorless filtrate by atmospheric pressure fractional distillation as a fraction boiling between 30 and 110° C. 24.4 g (35% mol/mol yield) of approximately 40% mol/mol pure TSA was obtained, as determined by GC/MS due to the overlapping peaks in ¹H NMR. Major impurities are DCS (approximately 15% mol/mol) and toluene (approximately 43% mol/mol), several products of condensation reaction between ammonia and TSA were also observed.

### Example 4

The effect of monochlorosilane purity on TSA yield was tested. As can be seen in the following table, higher purity monochlorosilane (MCS) produces larger quantities of TSA:

| | | | | | | (a)(SiH₃)₂N—SiH₂—NH(SiH₃) |
|---|---|---|---|---|---|---|
| | | | | | | Or |
| | | | | | | (b)(SiH₃)₂N—SiH₂—N(SiH₃)₂ |
| MCS Purity | | | | | | or |
| (manufacturer | Excess | TSA | DSA | TSA-Cl | TSA-Cl₂ | (c)(SiH₃)₂N—SiHCl—N(SiH₃)₂ |
| a or b) | MCS (% | (% | (% | (% | (% | (% |
| (% mol/mol) | mol/mol) | mol/mol) | mol/mol) | mol/mol) | mol/mol) | mol/mol) |
| 99.5 (a) | 20 | 76 | — | 9 | — | 5 (a) |
| 98.7 (a) | 0 | 64 | 24 | — | — | 9 (a) |
| 92 (a) | 0 | 86 | 8 | — | — | 5 (a) |
| 92 (a) | 25 | 99 | — | 1 | — | — |
| 90 (a) | 4 | 62 | — | 22 | — | 15 (b) |
| 80 (b) | 37 | 44 | — | 36 | 3 | 12 (b) and |
| | | | | | | 5 (c) |
| 57 (b) | 25 | 20 | — | 38 | 12 | 16 (b) and |
| | | | | | | 14 (c) |
| 12 (b) | 0 | — | — | — | — | — |

### Example 5

SiN films were deposited by low pressure chemical vapor deposition at 550° C. with ammonia as a reactant. One deposition utilized un-purified TSA, which typically contains 97% TSA and trace metals, each in the 100+ ppb range. The second deposition utilized distilled TSA, containing 99.5% TSA and trace metals, each in the less than 50 ppb range. The silicon nitride films were then analyzed for metal contamination by Vapor Phase Decomposition ICP-MS. The surface analysis, shown in the table below, clearly reveals film contamination resulting from the usage of the un-purified TSA as compared to those using distilled TSA.

| | | Surface Analysis | Surface Analysis |
|---|---|---|---|
| | Method | Distilled TSA | Un-Purified TSA |
| | Detection | SiN films 550° C. × | SiN films 550° C. × |
| Element | Limits | 10¹⁰ atoms/cm² | 10¹⁰ atoms/cm² |
| Aluminum | 0.1 | 1.6 | 12 |
| Calcium | 0.1 | 4.5 | 8.1 |
| Chromium | 0.05 | <0.05 | 0.18 |
| Copper | 0.03 | <0.03 | 0.79 |
| Iron | 0.05 | 0.072 | 2.3 |
| Magnesium | 0.1 | 3.4 | 4.3 |
| Nickel | 0.03 | 0.041 | 1.7 |
| Potassium | 0.1 | <0.1 | 6.0 |
| Sodium | 0.1 | 0.32 | 6.0 |
| Titanium | 0.05 | <0.05 | 1.1 |
| Zinc | 0.03 | 0.041 | 0.67 |

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

What is claimed is:

1. A method of producing trisilylamine (TSA), the method comprising:
a. adding a monohalosilane to a reactor containing an anhydrous solvent to form a solution at a temperature ranging from approximately −100° C. to approximately 0° C.;
b. adding anhydrous ammonia gas to the solution formed in 1a to produce a mixture;
c. stirring the mixture of 1b to form a stirred mixture; and
d. isolating TSA from the stirred mixture obtained in 1c by distillation.

2. The method of claim 1, further comprising removing solid by-products from the stirred mixture by filtration prior to isolating TSA, wherein the TSA is isolated from the filtered stirred mixture.

3. The method of claim 1, wherein a molar ratio of the monohalosilane to the anhydrous ammonia gas is between 0.75:1 and 1.5:1.

4. The method of claim 1, wherein the monohalosilane has a purity ranging from approximately 90% mol/mol to approximately 100% mol/mol.

5. The method of claim 1, wherein the monohalosilane contains approximately 0% mol/mol to approximately 5% mol/mol dihalosilane.

6. The method of claim 1, wherein the monohalosilane is monochlorosilane.

7. The method of claim 1, wherein the anhydrous solvent is selected from the group consisting of hydrocarbons, halo-hydrocarbons, halocarbons, ethers, polyethers, and tertiary amines.

8. The method of claim 7, wherein the anhydrous solvent is selected from the group consisting of toluene, heptane, ethylbenzene, and xylenes.

9. The method of claim 8, wherein the anhydrous solvent is toluene.

10. The method of claim 1, wherein the temperature of both addition steps ranges from approximately −78° C. to approximately −60° C.

11. The method of claim 1, wherein the distillation is atmospheric fractional distillation or vacuum fractional distillation.

12. The method of claim 1, wherein the distillation is atmospheric fractional distillation.

13. The method of claim 1, wherein the isolated TSA has a purity ranging from approximately 50% mol/mol to approximately 90% mol/mol.

14. The method of claim 13, further comprising purifying the isolated TSA by fractional distillation.

15. The method of claim 14, wherein the purified TSA has a purity ranging from approximately 97% mol/mol to approximately 100% mol/mol.
